(19) United States
(12) Patent Application Publication
(10) Pub. No.: US 2020/0027439 A1
(43) Pub. Date: Jan. 23, 2020

(54) INTELLIGENT TEXT TO SPEECH PROVIDING METHOD AND INTELLIGENT COMPUTING DEVICE FOR PROVIDING TTS

(71) Applicant: LG ELECTRONICS INC., Seoul (KR)

(72) Inventors: Youjin LEE, Seoul (KR); Minjeong KANG, Seoul (KR); Youngjoon PARK, Seoul (KR); Jinwan BAE, Seoul (KR); Hyojin WON, Seoul (KR)

(73) Assignee: LG ELECTRONICS INC., Seoul (KR)

(21) Appl. No.: 16/586,724

(22) Filed: Sep. 27, 2019

(30) Foreign Application Priority Data
Aug. 5, 2019 (KR) 10-2019-0095080

(51) Int. Cl. G10L 13/04; G06K 9/46; G10L 13/047; G06N 3/04; G06N 3/08

(52) U.S. Cl. CPC G10L 13/043; G06K 9/46; G06K 2209/01; G06N 3/04; G06N 3/08; G10L 13/047

(57) ABSTRACT

An intelligent TTS providing method and an intelligent computing device providing TTS are disclosed. An intelligent TTS providing method according to an embodiment of the present disclosure can seamlessly provide continuous TTS by receiving a text read command, adjusting a photographing angle of a camera such that a position of an object on which text is written is included in the photographing angle, photographing the object, converting the text written on the object into a speech and outputting the speech. One or more of the intelligent computing device and artificial intelligent speaker of the present disclosure can be associated with artificial intelligence (AI) modules, unmanned aerial vehicle (UAV) robots, augmented reality (AR) devices, virtual reality (VR) devices, 5G service related devices, etc.

### CROSS-REFERENCE TO RELATED APPLICATION(S)

This application is based on and claims priority under 35 U.S.C. 119 to Korean Patent Application No. 10-2019-0095080, filed on Aug. 5, 2019, in the Korean Intellectual Property Office, the disclosure of which is herein incorporated by reference in its entirety.

### BACKGROUND OF THE INVENTION

### Field of the Invention

The present disclosure relates to an intelligent TTS providing method and an intelligent computing device which provides TTS and, more specifically, to an intelligent TTS providing method capable of providing realistic TTS to users and an intelligent computing device which provides TTS.

### Related Art

Artificial intelligent speakers provide a function of reading picture books for children who cannot read letters or cannot perfectly understand the meanings of words.

Further, artificial intelligent speakers allow children to be able to concentrate on reading for a long time without depending on parents by reading books instead of parents.

Accordingly, artificial intelligent speakers aid in language development of children with immature brains.

Meanwhile, conventional artificial intelligent speakers (book-reading devices) can read only a designated book or book placed at a fixed position.

Furthermore, conventional artificial intelligent speakers recognize books within a narrow range and have a low degree of freedom of book location.

### SUMMARY OF THE INVENTION

An object of the present disclosure is to meet the needs and solve the problems.

Further, an object of the present disclosure is to provide an intelligent TTS providing method for providing optimized TTS to users irrespective of multilateral locations of books and an intelligent computing device providing TTS.

An intelligent TTS providing method according to an embodiment of the present disclosure includes: receiving a text read command; adjusting a photographing angle of a camera such that a position of an object on which text is written is included in the photographing angle of the camera; photographing the object using the camera; and converting the text written on the photographed object into a speech and outputting the speech.

The intelligent TTS providing method may further include readjusting the photographing angle of the camera such that the center of the photographing angle of the camera is directed to a second part of the text from a first part of the text before the second part of the text is converted into a speech after the first part of the text is converted into a speech and output.

The intelligent TTS providing method may further include: readjusting the photographing angle of the camera in a direction opposite a movement direction of the intelligent computing device when movement of the intelligent computing device is detected; and readjusting the photographing angle of the camera in the same direction as a movement direction of the object when movement of the object is detected.

The intelligent TTS providing method may further include: acquiring use history data per user; and providing information on a recommended book per user.

The acquiring of the use history data per user may include acquiring written documents per user, and acquiring the use history data per user on the basis of the written documents per user.

The use history data per user may include data related to audio provision command use history per user and conversation history per user.

The providing of the information on a recommended book per user may include: extracting feature values from the use history data per user; inputting the feature values to a previously learned deep learning model; and acquiring the information on a recommended book per user on the basis of output of the deep learning model.

The intelligent TTS providing method may further include receiving, from a network, downlink control information (DCI) used to schedule transmission of the use history data per user, wherein the use history data per user is transmitted to the network on the basis of the DCI.

The intelligent TTS providing method may further include performing an initial access procedure with the network on the basis of a synchronization signal block (SSB), wherein the use history data per user is transmitted to the network over a PUSCH and the SSB and a DM-RS of the PUSCH are QCLed for QCL type D.

The intelligent TTS providing method may further include: controlling a communication unit to transmit the use history data per user to an AI processor included in the network; and controlling the communication unit to receive AI-processed information from the AI processor, wherein the AI-processed information is the information on a recommended book per user.

The converting of the text into a speech and outputting the speech may include converting the text through a different conversion mode from a conventional conversion mode when a command for reading the same text is received a critical number of times or more.

The different conversion mode may include the intonation or speed of a speech converted from the text.

The intelligent TTS providing method may further include outputting audio associated with the object photographed by the camera.

The outputting of audio associated with the object may include outputting a result of analysis of an image when the object is the image.

The outputting of audio associated with the object may include outputting an onomatopoeic word related to text when the object is the text.

An intelligent computing device providing TTS according to an embodiment includes: a communication unit included in the intelligent computing device; a speaker; a camera; an angle controller for adjusting a photographing angle of the camera; a processor; and a memory including a command executable by the processor, wherein the command controls the intelligent computing device configured to receive a text read command through the communication unit, to adjust a photographing angle of the camera such that a position of an object on which text is written is included in the photographing angle of the camera through the angle controller, to photograph the object using the camera, and to convert the text written on the photographed object into a speech and output the speech through the speaker.

The processor may readjust the photographing angle of the camera such that the center of the photographing angle of the camera is directed to a second part of the text from a first part of the text before the second part of the text is converted into a speech after the first part of the text is converted into a speech and output.

The processor may readjust the photographing angle of the camera in a direction opposite a movement direction of the intelligent computing device when movement of the intelligent computing device is detected and readjust the photographing angle of the camera in the same direction as a movement direction of the object when movement of the object is detected.

The processor may acquire use history data per user and provide information on a recommended book per user.

A recording medium according to another embodiment of the present disclosure is a non-transitory computer-readable medium storing a computer-executable component configured to be executed by one or more processors of a computing device, the computer-executable component being configured to receive a text read command, to adjust a photographing angle of a camera such that a position of an object on which text is written is included in the photographing angle of the camera, to photograph the object, and to convert the text written on the photographed object into a speech and output the speech.

### BRIEF DESCRIPTION OF THE DRAWINGS

The accompanying drawings, included as part of the detailed description in order to provide a thorough understanding of the present disclosure, provide embodiments of the present disclosure and together with the description, describe the technical features of the present disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 illustrates an intelligent computing device according to an embodiment of the present disclosure.

FIG. 5 is a block diagram of an AI device according to an embodiment of the present disclosure.

FIG. 6 is a diagram for describing a system in which an intelligent computing device and an AI device are connected according to an embodiment of the present disclosure.

FIG. 7 is a flowchart showing an intelligent TTS providing method of an intelligent computing device according to an embodiment of the present disclosure.

FIG. 8 is a flowchart showing a photographing angle adjustment step of FIG. 7.

FIG. 9 illustrates an example in which the intelligent computing device adjusts a photographing angle in a direction in which an object is located.

FIG. 10 illustrates an example in which the intelligent computing device adjusts a photographing angle along a currently read text part.

FIG. 11 illustrates an example in which the intelligent computing device guides movement of an object.

FIG. 12 illustrates an example of converting displaced text to a speech.

FIG. 13 illustrates an example of adjusting a camera photographing angle in a direction in which the intelligent computing device or an object is moved.

FIG. 14 is a diagram for describing an example of recommending a book to a user in an embodiment of the present disclosure.

FIG. 15 is a diagram for describing another example of determining a drowsy state in an embodiment of the present disclosure.

The accompanying drawings, which are included to provide a further understanding of the disclosure and are incorporated in and constitute a part of this specification, illustrate embodiments of the disclosure and together with the description serve to explain the principles of the disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

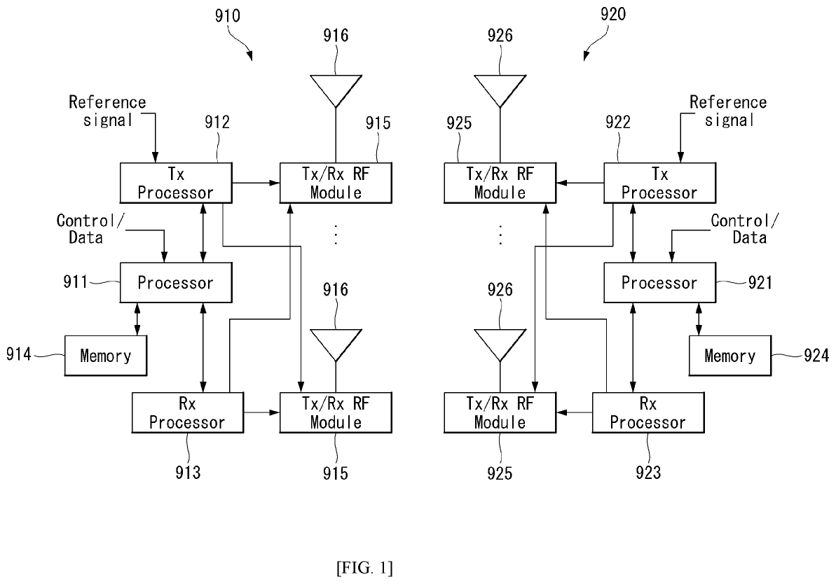

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

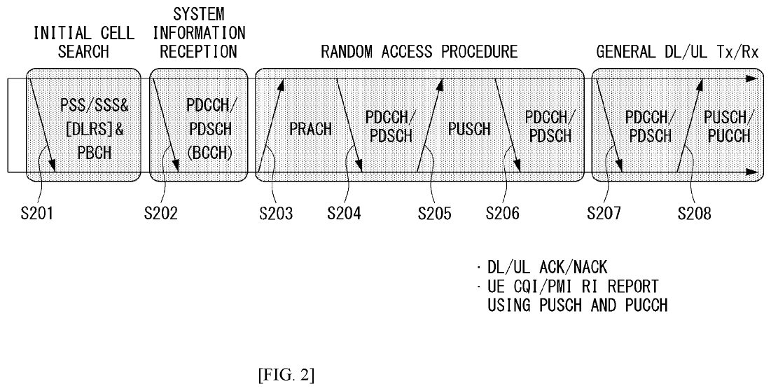

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtained through an SSS of the cell, and information on the cell ID among 336 cell ID groups is provided/obtained through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

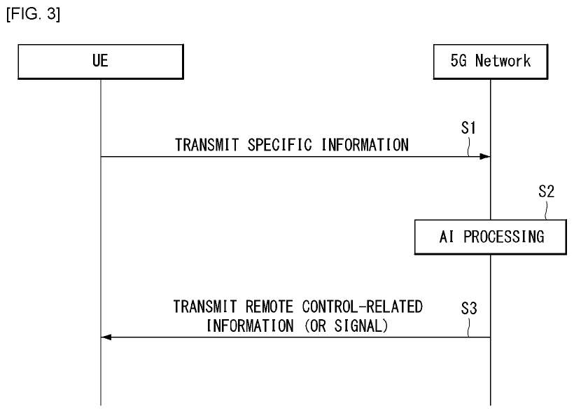

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

In the following specification, the home IoT server may be defined as an intelligent computing device for selecting a voice enabled device, and the home IoT device may be defined as a voice recognition device for recognizing a start word. In addition, the activation word may be defined as a user's speech for activating a specific IoT device.

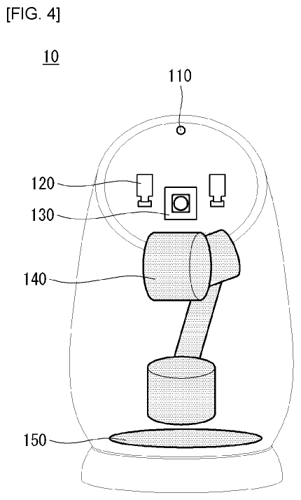

FIG. 4 illustrates an intelligent computing device according to an embodiment of the present disclosure.

As shown in FIG. 4, an artificial intelligent speaker may be exemplified as an example of an intelligent computing device 10.

The intelligent computing device 10 includes a microphone 110, a display 120, a camera 130, an angle controller 140 and a speaker 150.

The microphone 110 can receive audio command of a user from the outside. For example, the microphone 110 can receive a wake word for waking up the intelligent computing device 10 from the outside. Here, the intelligent computing device 10 can wake up upon reception of the wake word. Further, the microphone 10 can receive, from the outside, a text read command (or TTS output command) for causing the intelligent computing device 10 to convert text written on an external object into a speech and output the speech. Here, the intelligent computing device 10 can photograph the text written on the external object, analyze the photographed text, convert the analyzed text into a speech and output the speech upon reception of the text read command.

The display 120 can display an image in the form of eyes. For example, the display 120 can display an image in the form of eyes in a direction in which text is written.

The camera 130 can photograph an external object and text written on the object.

The angle controller 140 can adjust a photographing angle of the camera 130. The angle controller 140 may be called a gimbal. The angle controller 140 can be controlled such that the photographing angle of the camera 130 is fixed to a predetermined angle.

The speaker 150 can output a converted speech to the outside in the form of a sound. For example, the speaker 150 can output the contents of text as a voice.

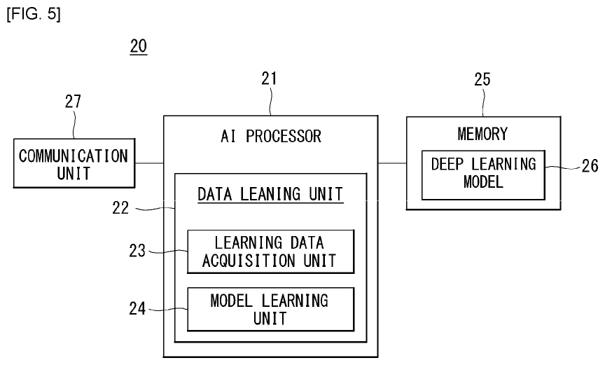

FIG. 5 is a block diagram of an AI device according to an embodiment of the present disclosure.

The AI device 20 may include an electronic device including an AI module capable of performing AI processing or a server including the AI module. In addition, the AI device 20 may be included in at least a part of the intelligent computing device 10 illustrated in FIG. 4 to be configured to perform at least some of the AI processing together.

The AI processing may include all operations related to the control of the intelligent computing device 10 shown in FIG. 4. For example, the intelligent computing device 10 may AI process the sensing data or the acquired data to perform processing/determination and control signal generation. Also, for example, the intelligent computing device 10 may AI process the data received through the communication unit to perform control of the intelligent computing device.

The AI device 20 may be a client device that directly uses the AI processing result or may be a device in a cloud environment that provides the AI processing result to another device.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, a tablet PC, and the like.

The AI processor 21 can learn a neural network using a program stored in the memory 25. Particularly, the AI processor 21 can learn a neural network for recognizing intelligent computing device related data. For example, the AI processor 21 can learn a neural network for extracting feature values from intelligent computing device related data (e.g., sensing data) and recommending a book to a user using the feature values as input values. Neural networks for recognizing intelligent computing device related data may be designed to simulate a human brain structure on a computer and may include a plurality of weighted network nodes that simulate the neurons of a human neural network. The plurality of network modes may transmit and receive data according to a connection relationship so that the neurons simulate synaptic activity of the neurons that send and receive signals through synapses. Here, the neutral network may include a deep-learning model developed from a neutral network model. In the deep-learning model, the plurality of network nodes may be located at different layers and may transmit or receive data according to a convolutional connection relationship. An example of the neutral network model includes various deep-learning techniques such as deep neutral networks (DNN), convolutional deep neutral networks (CNN), a Recurrent Boltzmann Machine (RNN), a Restricted Boltzmann Machine (RBM), deep belief networks (DBN), or a Deep Q-Network, and may be applied to a computer vision, voice recognition, natural language processing, voice/signal processing, or the like.

Meanwhile, the processor which performs the above-described function may be a general purpose processor (for example, CPU), but may be an AI dedicated processor (for example, a GPU) for artificial intelligence learning.

The memory 25 may store various programs and data necessary for an operation of the AI device 20. The memory 25 may be implemented as a nonvolatile memory, a volatile memory, a flash memory, a hard disk drive (HDD), a solid state drive (SDD), or the like. The memory 25 is accessed by the AI processor 21, and reading/writing/modifying/deleting/update of data by the AI processor 21 may be executed. In addition, the memory 25 may store a neutral network model (for example, a deep-learning model 26) generated through a learning algorithm for classification/recognition of data according to an embodiment of the present disclosure.

Meanwhile, the AI processor 21 may include a data learning unit 22 which learns a neutral network for classifying/recognizing data. The data learning unit 22 can learn a criteria as to which learning data to use to determine classification/recognition of the data, and can learn a criteria about how to classify and recognize data using learning data. The data learning unit 22 may learn the deep-learning model by acquiring the learning data to be used for learning and applying the acquired learning data to the deep-learning model.

The data learning unit 22 may be manufactured in a form of at least one hardware chip and mounted on the AI device 20. For example, the data learning unit 22 may be manufactured in a form of a dedicated hardware chip for artificial intelligence (AI), or may be manufactured as a portion of a general purpose processor (CPU) or a graphic dedicated processor (GPU) and mounted on the AI device 20. In addition, the data learning unit 22 may be implemented as a software module.

The data learning unit 22 is implemented as a software module (or program module including instruction), the software module may be stored in a computer readable non-transitory computer readable media. In this case, at least one software module may be provided by an operating system (OS) or may be provided by an application.

The data learning unit 22 may include a learning data acquisition unit 23 and a model learning unit 24.

The learning data acquisition unit 23 can acquire learning data required for the neutral network model to classify and recognize data. For example, the learning data acquisition unit 23 may obtain an image of the IoT device for inputting to a neural network model as learning data.

The model learning unit 24 may learn using the acquired learning data so that the neutral network model has a determination criteria about how to classify predetermined data. In this case, the model learning unit 24 can cause the neutral network model to learn, through supervised learning using at least a portion of the learning data as the determination criteria. Alternatively, the model learning unit 24 self-learns using the learning data without guidance, and thus, can cause the neutral network model to learn through unsupervised learning finding the determination criteria. Moreover, the model learning unit 24 can cause the neutral work model to learn, through reinforcement learning using a feedback which determines whether a result of a situation determination according to the learning is correct. In addition, the model learning unit 24 can cause the neutral network to learn, using a learning algorithm including error back-propagation or gradient decent.

If the neutral network model is learned, the model learning unit 24 can store the learned neutral network model in a memory. The model learning unit 24 may store the learned neutral network model in a memory of a server connected to the AI device 20 in a wire network or a wireless network.

The data learning unit 22 may further include a learning data preprocessor (not shown) and a learning data selector (not shown) so as to improve an analysis result of a recognition model or save a resource or time required for generating the recognition model.

The learning data preprocessor may preprocess the acquired data so that the acquired data may be used in learning for determining a situation. For example, the learning data preprocessor may process the acquired data into a preset format so that the model learning unit 24 can use the learning data acquired for learning to recognize an image.

Moreover, the learning data selector may select data required for the learning of the learning data acquired by the learning data acquisition unit 23 and the learning data preprocessed by the preprocessor. The selected learning data may be provided to the model learning unit 24. For example, by detecting a specific area of a characteristic value of a message obtained from the device information providing device 10, the learning data selection unit may select only data of syllables included in the specific area as learning data.

In addition, the data learning unit 22 may further include a model evaluator (not shown) to improve the analysis result of the neutral network model.

The model evaluator may input evaluation data into the neutral network model, and allow the model learning unit 24 to relearn when the analysis result output from the evaluation data does not satisfy a predetermined criteria. In this case, the evaluation data may be predefined data for evaluating the recognition model. For example, the model evaluator may evaluate that the predetermined criteria are not satisfied when the number or ratio of the evaluation data whose analysis result is not accurate among the analysis results of the learned recognition model for the evaluation data exceeds a predetermined threshold value.

The communication unit 27 may transmit an AI processing result by the AI processor 21 to an external electronic device.

Here, the external electronic device may be defined as an autonomous vehicle. Moreover, the AI device 20 may be defined as another vehicle or 5G network which communicates with the autonomous driving module vehicle. Meanwhile, the AI device 20 may be implemented to be functionally embedded in an autonomous driving module provided in the vehicle. In addition, the 5G network may include a server or a module which performs an autonomous driving related control.

Meanwhile, the AI device 20 shown in FIG. 4 is described to be functionally divided into the AI processor 21, the memory 25, the communication unit 27, or the like. However, note that the above-mentioned components may be integrated into one module and may be called as an AI module.

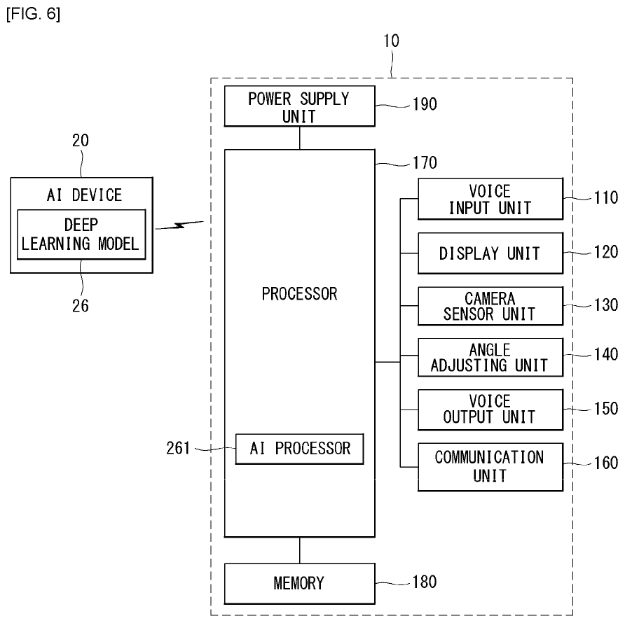

FIG. 6 is a diagram illustrating a system in which an intelligent computing device and an AI device are connected according to an embodiment of the present disclosure.

Referring to FIG. 6, the intelligent computing device 10 may transmit data requiring AI processing to the AI device 20 through a communication unit, and the AI device 20 including the deep learning model 26 may perform deep learning. AI processing results using the model 26 may be sent to the intelligent computing device 10. The AI device 20 may refer to the contents described with reference to FIG. 5.

The intelligent computing device 10 may include a microphone (voice input unit) 110, a display (display unit) 120, a camera (camera sensor unit) 130, an angle adjusting unit 140 described above and a speaker (voice output unit) 150, and additionally, an interface unit (not shown), a memory 180, a processor 170, a power supply unit 190, and the processor 170. The processor may further include an AI processor 261.

The interface unit may include at least one of a communication module, a terminal, a pin, a cable, a port, a circuit, an element, and an apparatus.

The memory 180 is electrically connected to the processor 170. The memory 180 may store basic data for the unit, control data for controlling the operation of the unit, and input/output data. The memory 180 may store data processed by the processor 170. The memory 180 may be configured by at least one of a ROM, a RAM, an EPROM, a flash drive, and a hard drive in hardware. The memory 180 may store various data for operations of the intelligent computing device 10, such as a program for processing or controlling the processor 170. The memory 180 may be integrated with the processor 170. According to an embodiment, the memory 180 may be classified into sub-components of the processor 170.

The power supply 190 may supply power to the intelligent computing device 10. The power supply unit 190 may receive power from a power source (eg, a battery) included in the intelligent computing device 10, and supply power to each unit of the intelligent computing device 10. The power supply unit 190 may be operated according to a control signal provided from the main ECU 240. The power supply unit 190 may include a switched-mode power supply (SMPS).

The processor 170 may be electrically connected to the memory 180, the interface unit 280, and the power supply unit 190 to exchange signals. The processor 170 may include application specific integrated circuits (ASICs), digital signal processors (DSPs), digital signal processing devices (DSPDs), programmable logic devices (PLDs), field programmable gate arrays (FPGAs), processors, and controllers. (controllers), micro-controllers (micro-controllers), microprocessors (microprocessors), may be implemented using at least one of the electrical unit for performing other functions.

The processor 170 may be driven by the power supplied from the power supply unit 190. The processor 170 may receive data, process data, generate a signal, and provide a signal while the power is supplied by the power supply 190.

The processor 170 may receive information from another electronic device in the intelligent computing device 10. The processor 170 may provide a control signal to another electronic device in the intelligent computing device 10 through the interface unit.

The intelligent computing device 10 may include at least one printed circuit board (PCB). The memory 180, the interface unit, the power supply unit 190, and the processor 170 may be electrically connected to the printed circuit board.

Hereinafter, another electronic device and the AI processor 261 in the intelligent computing device connected to the interface unit will be described in more detail.

Meanwhile, the intelligent computing device 10 transmits data obtained from the intelligent computing device 10 to the AI device 20 through the communication unit 160, and the AI device 20 transmits the neural network model 26 to the transmitted data.) Can be sent to the intelligent computing device 10. The intelligent computing device 10 may recommend the book to the user based on the received AI processing data. As another example, the AI processing data itself may include data related to a book to be recommended to the user.

The communicator 160 may exchange signals with a device located outside the intelligent computing device 10. The communication unit 160 may exchange signals with at least one of an infrastructure (for example, a server and a broadcasting station), an IoT device, another intelligent computing device, and a terminal. The communication unit 160 may include at least one of a transmit antenna, a receive antenna, a radio frequency (RF) circuit capable of implementing various communication protocols, and an RF element to perform communication.

Meanwhile, the AI processor 261 may generate data related to a book for recommending to a user by using data transmitted from the intelligent computing device 10.

According to an embodiment of the present disclosure, the communication unit 160 may obtain recommendation book data for the user. The communicator 160 may transfer the obtained recommendation book data to the processor 170.

According to an embodiment of the present disclosure, the processor 170 may provide a user with a TTS related to the recommendation book by using the recommendation book data transmitted from the communication unit 160.

In the above, the outlines for performing AI processing by applying the 5G communication and the 5G communication necessary to implement the intelligent TTS providing method according to an embodiment of the present disclosure, and transmitting and receiving the AI processing result.

Hereinafter, a method of providing intelligent TTS to users according to an embodiment of the present disclosure will be described with reference to necessary drawings.

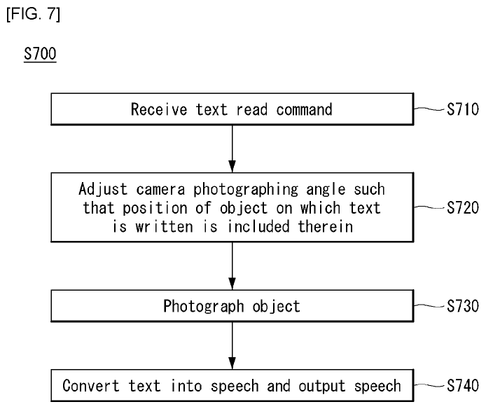

FIG. 7 is a flowchart showing an intelligent TTS providing method of an intelligent computing device according to an embodiment of the present disclosure.

As shown in FIG. 7, the intelligent computing device 10 can perform the intelligent TTS providing method through step S700 of FIG. 7 which will be described in detail below.

First, the intelligent computing device 10 can receive a text read command from the outside (S710).

Subsequently, the intelligent computing device 10 can adjust a photographing angle of the camera using the angle controller such that the position of an object on which text is written from among surrounding objects is included within the photographing angle (S720).

Thereafter, the intelligent computing device 10 can photograph the object on which the text is written using the camera at the adjusted photographing angle (S730).

Finally, the intelligent computing device 10 can analyze the photographed text, convert the text into a speech and output the speech through the speaker (S740).

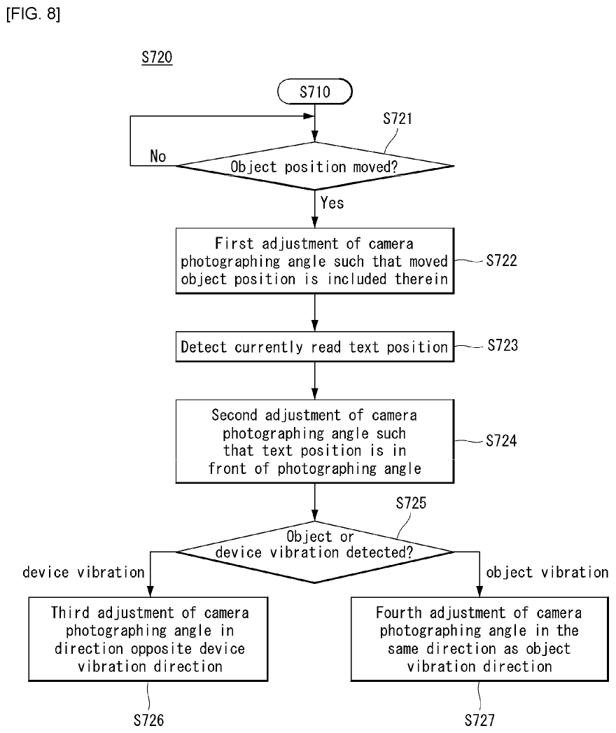

FIG. 8 is a flowchart showing the photographing angle adjustment step of FIG. 7 in detail.

As shown in FIG. 8, according to an embodiment of the present disclosure, the intelligent computing device 10 can determine whether the position of the object on which the text is written has been moved after execution of step S710 (S721).

When it is determined that the position of the object on which the text is written has been moved, the intelligent computing device 10 can perform first adjustment (first readjustment) on the camera photographing angle such that the moved position of the object is included in the photographing angle (S722). Here, the intelligent computing device 10 can photograph the text using the camera at the first readjusted camera photographing angle, analyze a first part of the text and convert the analyzed first part into a speech.

Thereafter, the intelligent computing device 10 can detect a position of currently read text (text of the first part) (S723).

Subsequently, the intelligent computing device 10 can perform second adjustment (second readjustment) on the camera photographing angle such that the position of the currently read text (the position of the text of the first part) is located in front of the photographing angle (S724).

Here, the intelligent computing device 10 can control not only the camera photographing angle but also the display such that the display faces the position of the currently read text.

Thereafter, the intelligent computing device 10 can determine whether vibration (or motion) of the object or the device (intelligent computing device 10) is detected (S725).

Here, the intelligent computing device 10 can include a sensor (e.g., an acceleration sensor) for detecting vibration of the object.

When vibration of the device (intelligent computing device 10) is detected as a determination result, the intelligent computing device 10 can perform third adjustment (third readjustment) on the camera photographing angle such that the camera photographing angle is in a direction opposite the vibration direction of the device (intelligent computing device 10) (S726).

Here, the intelligent computing device 10 can maintain a text photographing angle uniform by readjusting the camera photographing angle such that the camera photographing angle is in a direction opposite the vibration direction of the device.

When vibration of the object instead of the device is detected as a determination result, the intelligent computing device 10 can perform fourth adjustment (fourth readjustment) on the camera photographing angle such that the camera photographing angle is in the same direction as the vibration direction of the object (S727).

Here, the intelligent computing device 10 can maintain a text photographing angle uniform by readjusting the camera photographing angle such that the camera photographing angle is in the same direction as the vibration direction of the object.

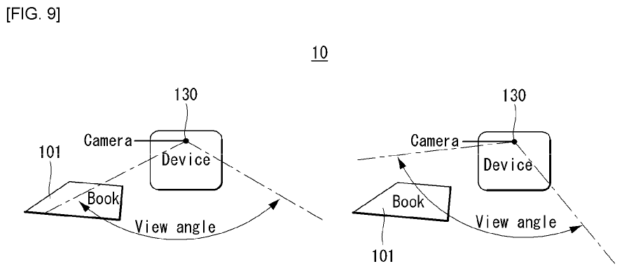

FIG. 9 illustrates an example in which the intelligent computing device adjusts a photographing angle in a direction in which an object is located.

As shown in FIG. 9, the intelligent computing device 10 can adjust the photographing angle (view angle) of the camera 130 such that the photographing angle can include a book (object) 101.

That is, when the book 101 is out of the photographing angle of the camera 130, the intelligent computing device 10 can control the angle controller 140 such that the photographing angle of the camera 130 includes the book 101.

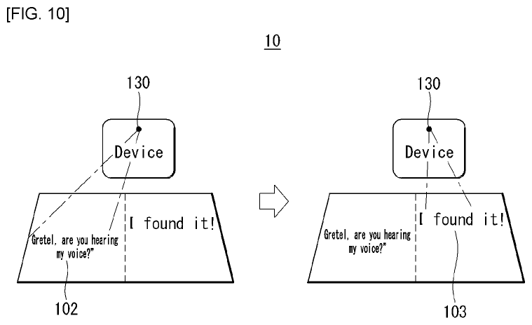

FIG. 10 illustrates an example in which the intelligent computing device adjusts the photographing angle along a currently read text part.

As shown in FIG. 10, the intelligent computing device 10 can adjust the photographing angle of the camera 130 using the angle controller such that the center of the photographing angle of the camera 130 is directed to a currently read first part (“Gretel, are you hearing my voice?”) 102.

Further, when a user starts to read a second part (“I found it!”) 103 of the text after reading the first part, the intelligent computing device 10 can control the angle controller such that the center of the photographing angle of the camera 130 is directed to the position of the second part.

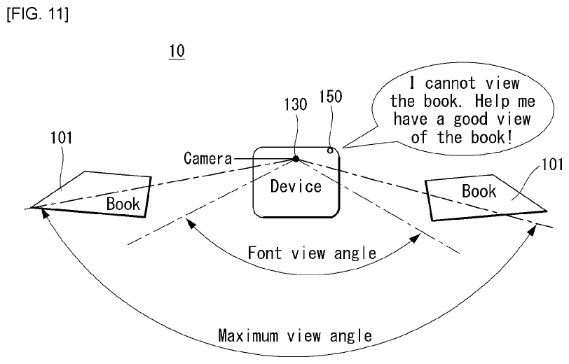

FIG. 11 illustrates an example in which the intelligent computing device guides movement of an object.

As shown in FIG. 11, the intelligent computing device 10 can detect that the book 101 is not positioned within a maximum view angle that is a maximum range of the photographing angle of the camera 130.

When the book 101 is not positioned within the maximum view angle that is the maximum range of the photographing angle of the camera 130, the intelligent computing device 10 can output an audio signal of “I cannot view the book. Help me have a good view of the book!” through the speaker 150.

For example, the intelligent computing device 10 can output the audio signal of “I cannot view the book. Help me have a good view of the book!” through the speaker 150 at predetermined intervals until the book 101 is positioned within the maximum view angle of the camera 130.

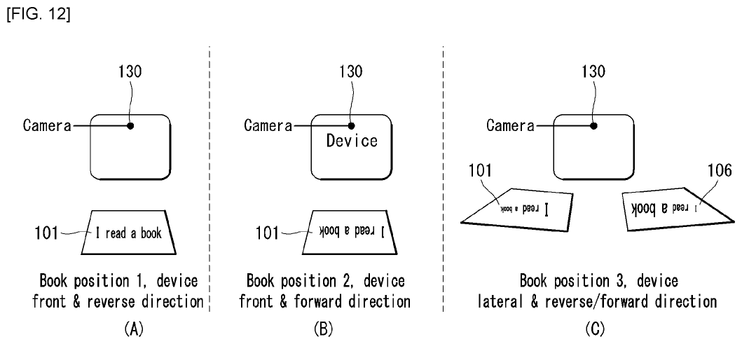

FIG. 12 illustrates an example of converting displaced text into a speech.

Text may be positioned in a reverse direction although the book 101 is disposed in front of the intelligent computing device 10 as shown in FIG. 12(A), the text may be positioned in a forward direction although the book 101 is disposed in front of the intelligent computing device 10 as shown in FIG. 12(B), or the text may be positioned in the reverse or forward direction while the book 101 is disposed on the side of the intelligent computing device 10 as shown in FIG. 12(C).

In the cases of FIGS. 12(A) to 12(C), the intelligent computing device 10 can extract the text photographed through the camera 130, convert an image captured using the camera 130 into a rectangular image in the forward direction through image processing before conversion of the photographed text into a speech, and recognize the text using the converted image.

Further, the intelligent computing device 10 can photograph the book 101, detect the size of the book 101 and perform image processing on the basis of the detected book size.

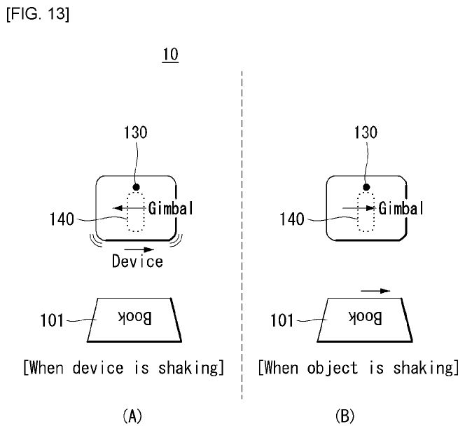

FIG. 13 illustrates an example of adjusting the camera photographing angle in a direction in which the intelligent device or an object is moved.

As shown in FIG. 13(A), when the intelligent computing device 10 moves to the right while converting text written on the object 101 into a speech and outputting the speech, the intelligent computing device 10 can adjust the photographing angle of the camera 130 by adjusting the angle controller (gimbal) 140 to the left that is a direction opposite the right direction in which the intelligent computing device 10 moves.

As shown in FIG. 13(B), when the object 101 moves to the right while the intelligent computing device 10 converts text written on the object 101 into a speech and outputs the speech, the intelligent computing device 10 can adjust the photographing angle of the camera 130 by adjusting the angle controller (gimbal) 140 to the right that is the same direction as the right direction in which the object 101 moves.

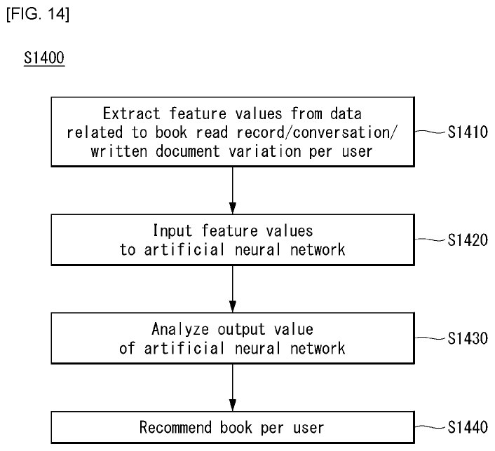

FIG. 14 is a diagram for describing an example of recommending a book to a user in an embodiment of the present disclosure.

First, the processor 170 of the intelligent computing device 10 can store, in the memory 180, data related to a book read record (history) per user, details of conversations of each user, written documents of users, and details of variations in written documents in order to recommend an optimal book to a user.

Further, in order to recommend an optimal book to a user, the processor 170 of the intelligent computing device 10 can store, in the memory 180, data related to a book read record (history) per user, details of conversations of each user, written documents of users, and details of variations in written documents and generate meta information (characteristic information per user) related to a book read frequency per user, a preferred category per user, a time period in which each user reads books often, a preferred author per user, and a preferred character per user, which is feature values of the stored data related to the book read record (history) per user, details of conversations of each user, written documents of users, and details of variations in written documents.

Here, the intelligent computing device 10 can profile a plurality of users using the generated meta information per user and recommend a book expected to have high preference for a corresponding user or a user having a propensity similar to that of the user. Here, the intelligent computing device 10 can recommend at least one book possessed by the user (stored in the memory) from among a plurality of recommendation target books in preference to other books.

For example, the intelligent computing device 10 can extract keywords from the titles of read books, align keywords with high extraction frequency and recommend a book including a keyword with highest frequency to the corresponding user in consideration of the user age. For example, when the book “Find Mona Lisa” (Kidsm) has been read three times, the intelligent computing device 10 can extract a keyword of “Mona Lisa” and recommend children's books including the keyword “Mona Lisa” (e.g., “Find real Mona Lisa! (Aram)” and “While does not Mona Lisa have eyebrows? (Korea Tolstoy)” to the user. Here, at a time when a keyword of the second book initially appears on the basis of similar keywords, the intelligent computing device 10 can connect the contents without editing the original text and output audio.

For example, the intelligent computing device 10 can recommend a more relevant book on the basis of dates or time periods on which or in which a user has read books often. For example, the intelligent computing device can extract books associated with a special event at a time three weeks before the special event such as New Year's day/Thanksgiving day/Christmas and preferentially recommend books of publishers with high frequency (upon determining that there is a high probability of a user purchasing the complete works) from among read books (e.g., Out first New Year's day story (Scholar), Bono Bono, a good thing will occur: Christmas story (Scholar)). Further, in the case of a time before going to sleep, the intelligent computing device 10 can recommend books for inducing a sleeping habit/teeth-brushing habit (e.g., Jake has beady eyes (Hansol education), It's time to sleep (Korea Tolstoy), and Bush your teeth (Kiwibooks)).

In addition, the intelligent computing device 10 can extract author information from read books and recommend other books of the same author when frequency increases on the basis of the author. For example, when the intelligent computing device has read the book “An eccentric mom (Baek Heena), the intelligent computing device 10 can extract author information on “Baek Heena” and recommend the books “Jangsootang Angel (Baek Heena)”, “Sugarplum (Baek Heena)”, “An eccentric guest (Baek Heena)” and the like of the same author.

Furthermore, the intelligent computing device 10 can recommend a book along with book cover information through the display. Further, the intelligent computing device 10 can transmit recommended information to a mobile device application of a plurality of user accounts registered as family members.

Further, when a user speaks to the intelligent computing device 10 for five seconds or longer while the intelligent computing device 10 is reading a book, the intelligent computing device 10 can stop reading, record a conversation with the user performed while looking at the user or a monologue, store the recorded conversation or monologue in the memory or an external server, and transmit the recorded conversation or monologue to mobile devices of user accounts registered as family members. Here, the intelligent computing device 10 can classify matters of concern of the user into categories on the basis of the recorded contents and analyze children language development stages. Here, the intelligent computing device 10 can analyze the children language development stages using an artificial neural network. Subsequently, the intelligent computing device 10 can recommend books belonging to a category of the same concern of another user to the corresponding user. Further, the intelligent computing device 10 can transmit recommended books to mobile devices of user accounts of family members for each language development stage.

Here, the intelligent computing device 10 can recognize written documents per user. The intelligent computing device 10 can separately store use history data such as book read records and conversation records for respective users for which written documents have been recognized and recommend different books to respective users.

Referring to FIG. 14, the processor 170 of the intelligent computing device 10 can extract feature values from data related to a book read record (history) per user, details of conversations of each user, written documents of users, and details of variations in written documents in order to recommend an optimal book to a user (S1410).

For example, the processor 170 can store the data related to a book read record (history) per user, details of conversations of each user, written documents of users, and details of variations in written documents in the memory of the intelligent computing device 10.

Here, the processor 170 can read the data related to a book read record (history) per user, details of conversations of each user, written documents of users, and details of variations in written documents stored in the memory of the intelligent computing device 10.

The processor 170 can extract feature values from the data related to a book read record (history) per user, details of conversations of each user, written documents of users, and details of variations in written documents. The feature values are determined to represent characteristic information per user, such as user propensity information, user preference information and user state information, in detail from among at least one feature that can be extracted from the data related to a book read record (history) per user, details of conversations of each user, written documents of users, and details of variations in written documents.

The processor 170 can control the feature values to be input to an artificial neural network (ANN) classifier trained to recommend a book per user (S1420).

The processor 170 can combine the extracted feature values to generate use history data per user. The use history data per user can be input to the ANN classifier trained to recommend a book per user on the basis of the extracted feature values.

The processor 170 can analyze output values of the ANN (S1430) and determine information about a recommended book per user on the basis of the output values of the ANN (S1440).

Although an example in which the operation of determining a recommended book per user through AI processing is implemented through processing of the intelligent computing device 10 is described in FIG. 14, the present disclosure is not limited thereto. For example, the AI processing may be performed on a 5G network on the basis of the use history data per user received from the intelligent computing device 10.

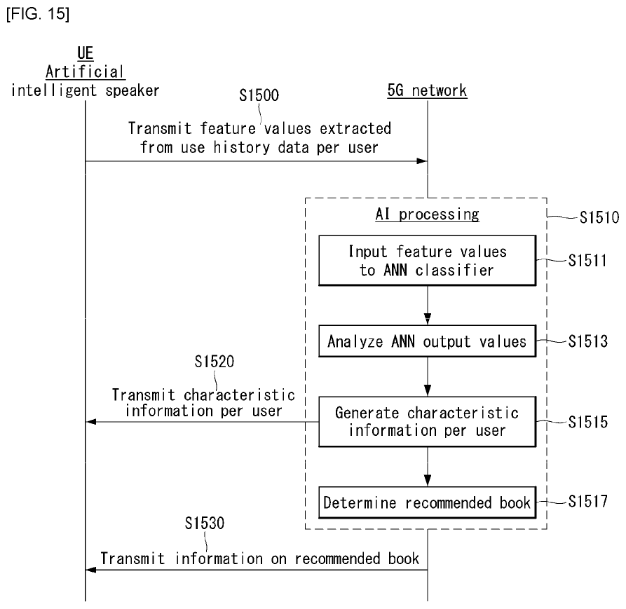

FIG. 15 is a diagram for describing another example of determining a drowsy state in an embodiment of the present disclosure.

The processor 170 can control the communication unit to transmit the use history data per user to an AI processor included in a 5G network. Further, the processor 170 can control the communication unit to receive AI-processed information from AI processor.

The AI-processed information can include information about a recommended book per user.

The intelligent computing device 10 can perform an initial access procedure with the 5G network in order to transmit the user history data per user including data related to a book read record, conversations and written document variations per user to the 5G network. The intelligent computing device 10 can perform the initial access procedure with the 5G network on the basis of a synchronization signal block (SSB).

Further, the intelligent computing device 10 can receive, from the network, downlink control information (DCI) used to schedule transmission of the use history data per user read from the memory of the intelligent computing device through a wireless communication unit.

The processor 170 can transmit the use history data per user to the network on the basis of the DCI.

The use history data per user can be transmitted to the network over a PUSCH, and the SSB and a DM-RS of the PUSCH can be QCLed for QCL type D.

Referring to FIG. 15, the intelligent computing device 10 can transmit feature values extracted from the use history data per user to a 5G network (S1500).

Here, the 5G network can include an AI processor or an AI system, and the AI system of the 5G network can perform AI processing on the basis of the received use history data per user (S1510).

Specifically, the AI system can input the feature values received from the intelligent computing device 10 to an ANN classifier (S1511). The AI system can analyze ANN output values (S1513), generate characteristic information per user from the ANN output values (S1515) and determine a recommended book per user (S1517).

Here, the 5G network can transmit information on a recommended book per user determined by the AI system to the intelligent computing device 10 through a wireless communication unit (S1530).

In addition, the AI system can transmit the characteristic information per user instead of the information on a recommended book per user to the intelligent computing device 10.

The intelligent computing device 10 may transmit only the use history data per user to the 5G network and the AI system included in the 5G network may extract feature values corresponding to characteristic information per user to be used as input of the ANN for determining information on a recommended book per user from the use history data per user.

Further, when the number of times of reading the same book exceeds a predetermined number of times, the intelligent computing device 10 can divide the contents of the book in units of spacing words, give emphasis points to different points from previous ones to set different intonation, and increase the speed by a predetermined multiple (e.g., 1.2 times).

Here, the intelligent computing device 10 can record user's reactions (laughing, speech and the like) to intonation variations and apply a preferred intonation when other books are read.

In addition, the intelligent computing device 10 can reproduce sound effects associated with recognized words while reading books. For example, when the word “sea” is read, the intelligent computing device 10 can output an onomatopoeic word such as “plash ˜” along with a speech converted from text while reproducing the roar of the waves as a background sound.

Further, the intelligent computing device 10 can recognize a picture photographed by the camera 130 and describe the contents included in the picture as audio. For example, when a user indicates a picture with a hand, the intelligent computing device 10 can photograph the picture using the camera and output a result obtained by analyzing the picture as audio. For example, the intelligent computing device 10 can analyze a specific picture while reading the book “Rapunzel” and output a voice “A blonde girl is standing in a tower”.

Further, the intelligent computing device 10 can generate meta information related to characters using records of books read thereby. Accordingly, the intelligent computing device 10 can combine the contents of more similar books including the same character. The intelligent computing device 10 can create an audio book from the combined contents of the books. For example, the intelligent computing device 10 can store corresponding contents of books in the memory or an external server while reading the books, create an audio book by combining related contents of books having similar characters when the number of times of reading books exceeds a predetermined number of times (10 times), and recommend the audio book. For example, the intelligent computing device 10 can compose a new plot using the wolf among characters in “The wolf and the seven young kids” and “Three little pigs” as the interface. Further, the intelligent computing device 10 can generate an audio book by combining the contents “Knock knock, Kids! It's mom” and “If you are our mom, show me your foot” (in “The wolf and the seven young kids”), the contents “The wolf gave a hard blow in anger. The house was standing motionless” (in “Three little pigs”) and the contents “She put flour on her feet and showed them” (in “The wolf and the seven young kids”) and recommend this to the user.

### Embodiment 1

An intelligent TTS providing method includes: receiving a text read command; adjusting a photographing angle of a camera such that a position of an object on which text is written is included in the photographing angle of the camera; photographing the object using the camera; and converting the text written on the photographed object into a speech and outputting the speech.

### Embodiment 2

In the embodiment 1, the intelligent TTS providing method may further include readjusting the photographing angle of the camera such that the center of the photographing angle of the camera is directed to a second part of the text from a first part of the text before the second part of the text is converted into a speech after the first part of the text is converted into a speech and output.

### Embodiment 3

In the embodiment 1, the intelligent TTS providing method may further include: readjusting the photographing angle of the camera in a direction opposite a movement direction of the intelligent computing device when movement of the intelligent computing device is detected; and readjusting the photographing angle of the camera in the same direction as a movement direction of the object when movement of the object is detected.

### Embodiment 4

In the embodiment 1, the intelligent TTS providing method may further include: acquiring use history data per user; and providing information on a recommended book per user.

### Embodiment 5

In the embodiment 4, the acquiring of the use history data per user may include acquiring written documents per user, and acquiring the use history data per user on the basis of the written documents per user.

### Embodiment 6

In the embodiment 5, the use history data per user may include data related to audio provision command use history per user and conversation history per user.

### Embodiment 7

In the embodiment 4, the providing of the information on a recommended book per user may include: extracting feature values from the use history data per user; inputting the feature values to a previously learned deep learning model; and acquiring the information on a recommended book per user on the basis of output of the deep learning model.

### Embodiment 8

In the embodiment 1, the intelligent TTS providing method may further include receiving, from a network, downlink control information (DCI) used to schedule transmission of the use history data per user, wherein the use history data per user is transmitted to the network on the basis of the DCI.

### Embodiment 9

In the embodiment 8, the intelligent TTS providing method may further include performing an initial access procedure with the network on the basis of a synchronization signal block (SSB), wherein the use history data per user is transmitted to the network over a PUSCH and the SSB and a DM-RS of the PUSCH are QCLed for QCL type D.

### Embodiment 10

In the embodiment 8, the intelligent TTS providing method may further include: controlling a communication unit to transmit the use history data per user to an AI processor included in the network; and controlling the communication unit to receive AI-processed information from the AI processor, wherein the AI-processed information is the information on a recommended book per user.

### Embodiment 11

In the embodiment 1, the converting of the text into a speech and outputting the speech may include converting the text through a different conversion mode from a conventional conversion mode when a command for reading the same text is received a critical number of times or more.

### Embodiment 12

In the embodiment 11, the different conversion mode may include the intonation or speed of a speech converted from the text.

### Embodiment 13

In the embodiment 1, the intelligent TTS providing method may further include outputting audio associated with the object photographed by the camera.

### Embodiment 14

In the embodiment 13, the outputting of audio associated with the object may include outputting a result of analysis of an image when the object is the image.

### Embodiment 15

In the embodiment 13, the outputting of audio associated with the object may include outputting an onomatopoeic word related to text when the object is the text.

### Embodiment 16

An intelligent computing device providing TTS includes: a communication unit included in the intelligent computing device; a speaker; a camera; an angle controller for adjusting a photographing angle of the camera; a processor; and a memory including a command executable by the processor, wherein the command controls the intelligent computing device configured to receive a text read command through the communication unit, to adjust a photographing angle of the camera such that a position of an object on which text is written is included in the photographing angle of the camera through the angle controller, to photograph the object using the camera, and to convert the text written on the photographed object into a speech and output the speech through the speaker.

### Embodiment 17

In the embodiment 16, the processor may readjust the photographing angle of the camera such that the center of the photographing angle of the camera is directed to a second part of the text from a first part of the text before the second part of the text is converted into a speech after the first part of the text is converted into a speech and output.

### Embodiment 18

In the embodiment 16, the processor may readjust the photographing angle of the camera in a direction opposite a movement direction of the intelligent computing device when movement of the intelligent computing device is detected and readjust the photographing angle of the camera in the same direction as a movement direction of the object when movement of the object is detected.

### Embodiment 19

In the embodiment 16, the processor may acquire use history data per user and provide information on a recommended book per user.

### Embodiment 20

A non-transitory computer-readable medium stores a computer-executable component configured to be executed by one or more processors of a computing device, the computer-executable component being configured to receive a text read command, to adjust a photographing angle of a camera such that a position of an object on which text is written is included in the photographing angle of the camera, to photograph the object, and to convert the text written on the photographed object into a speech and output the speech.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

An intelligent TTS providing method and an effect of an intelligent computing device providing TTS according to an embodiment of the present disclosure will be described below.

The present disclosure can provide continuous TTS seamlessly by changing a camera angle in response to change in the position of a book.

Further, the present disclosure can provide TTS with a high level of satisfaction to a user by recommending a book with high preference to the user.

Further, the present disclosure can provide realistic TTS to a user by changing a TTS output pattern on the basis of the number of times of reading a book by an artificial intelligent speaker.

Further, the present disclosure can generate an audio book with new contents by combining contents of more similar books to provide TTS with a high level of interest to a user.

Further, the present disclosure can provide TTS suitable for intelligence development of a user by analyzing language development process and matters of interest of the user on the basis of conversations of the user.

Further, the present disclosure can provide TTS suitable for a growth process of a user by recommending books of different levels on the basis of written document recognition of the user.

Further, the present disclosure can provide realistic TTS to a user by outputting sound effects related to text included in a book.

The effect obtained in the present disclosure is not limited to the above-mentioned effects, and other effects not mentioned will be clearly understood by those skilled in the art from the following description.

What is claimed is:

1. An intelligent TTS providing method, comprising:
receiving a text read command;
adjusting a photographing angle of a camera such that a position of an object on which text is written is included in the photographing angle of the camera;
photographing the object using the camera; and
converting the text written on the photographed object into a speech and outputting the speech.

2. The intelligent TTS providing method of claim 1, further comprising readjusting the photographing angle of the camera such that the center of the photographing angle of the camera is directed to a second part of the text from a first part of the text before the second part of the text is converted into a speech after the first part of the text is converted into a speech and output.

3. The intelligent TTS providing method of claim 1, further comprising:
readjusting the photographing angle of the camera in a direction opposite a movement direction of the intelligent computing device when movement of the intelligent computing device is detected; and
readjusting the photographing angle of the camera in the same direction as a movement direction of the object when movement of the object is detected.

4. The intelligent TTS providing method of claim 1, further comprising:
acquiring use history data per user; and
providing information on a recommended book per user.

5. The intelligent TTS providing method of claim 4, wherein the acquiring of the use history data per user comprises:
acquiring written documents per user; and
acquiring the use history data per user on the basis of the written documents per user.

6. The intelligent TTS providing method of claim 5, wherein the use history data per user includes data related to audio provision command use history per user and conversation history per user.

7. The intelligent TTS providing method of claim 4, wherein the providing of the information on a recommended book per user comprises:
extracting feature values from the use history data per user;
inputting the feature values to a previously learned deep learning model; and
acquiring the information on a recommended book per user on the basis of output of the deep learning model.

8. The intelligent TTS providing method of claim 1, further comprising receiving, from a network, downlink control information (DCI) used to schedule transmission of the use history data per user,
wherein the use history data per user is transmitted to the network on the basis of the DCI.

9. The intelligent TTS providing method of claim 8, further comprising performing an initial access procedure with the network on the basis of a synchronization signal block (SSB),
wherein the use history data per user is transmitted to the network over a PUSCH, and the SSB and a DM-RS of the PUSCH are QCLed for QCL type D.

10. The intelligent TTS providing method of claim 8, further comprising:
controlling a transceiver to transmit the use history data per user to an AI processor included in the network; and
controlling the transceiver to receive AI-processed information from the AI processor,
wherein the AI-processed information is the information on a recommended book per user.

11. The intelligent TTS providing method of claim 1, wherein the converting of the text into a speech and outputting the speech comprises converting the text through a different conversion mode from a conventional conversion mode when a command for reading the same text is received a critical number of times or more.

12. The intelligent TTS providing method of claim 11, wherein the different conversion mode includes the intonation or speed of a speech converted from the text.

13. The intelligent TTS providing method of claim 1, further comprising outputting audio associated with the object photographed by the camera.

14. The intelligent TTS providing method of claim 13, wherein the outputting of audio associated with the object comprises outputting a result of analysis of an image when the object is the image.

15. The intelligent TTS providing method of claim 13, wherein the outputting of audio associated with the object comprises outputting an onomatopoeic word related to text when the object is the text.

16. An intelligent computing device providing TTS, comprising:
a transceiver included in the intelligent computing device;
a speaker;
a camera;
an angle controller for adjusting a photographing angle of the camera;
a processor; and
a memory including a command executable by the processor,
wherein the command controls the intelligent computing device configured:
to receive a text read command through the transceiver;
to adjust a photographing angle of the camera such that a position of an object on which text is written is included in the photographing angle of the camera through the angle controller;
to photograph the object using the camera; and
to convert the text written on the photographed object into a speech and output the speech through the speaker.

17. The intelligent computing device of claim 16, wherein the processor readjusts the photographing angle of the camera such that the center of the photographing angle of the camera is directed to a second part of the text from a first part of the text before the second part of the text is converted into a speech after the first part of the text is converted into a speech and output.

18. The intelligent computing device of claim 16, wherein the processor readjusts the photographing angle of the camera in a direction opposite a movement direction of the intelligent computing device when movement of the intelligent computing device is detected and readjusts the photographing angle of the camera in the same direction as a movement direction of the object when movement of the object is detected.

19. The intelligent computing device of claim 16, wherein the processor acquires use history data per user and provides information on a recommended book per user.

20. A non-transitory computer-readable medium storing a computer-executable component configured to be executed by one or more processors of a computing device,
wherein the computer-executable component is configured:
to receive a text read command;
to adjust a photographing angle of a camera such that a position of an object on which text is written is included in the photographing angle of the camera;
to photograph the object; and
to convert the text written on the photographed object into a speech and output the speech.
